(19) United States
(12) Patent Application Publication
(10) Pub. No.: US 2024/0346312 A1
(43) Pub. Date: Oct. 17, 2024

(54) ELECTRONIC DEVICE AND CONTROLLING METHOD OF ELECTRONIC DEVICE

(71) Applicant: Samsung Electronics Co., Ltd., Suwon-si (KR)

(72) Inventors: Jijoong MOON, Suwon-si (KR); Parichay KAPOOR, Suwon-si (KR); Jihoon LEE, Suwon-si (KR); Hyeonseok LEE, Suwon-si (KR); Myungjoo HAM, Suwon-si (KR)

(21) Appl. No.: 18/750,655

(22) Filed: Jun. 21, 2024

Related U.S. Application Data
(63) Continuation of application No. PCT/KR2022/020897, filed on Dec. 20, 2022.

(30) Foreign Application Priority Data
Dec. 22, 2021 (KR) 10-2021-0185454
Mar. 14, 2022 (KR) 10-2022-0031573

(51) Int. Cl. G06N 3/08; G06N 3/04

(52) U.S. Cl. CPC G06N 3/08; G06N 3/04

(57) ABSTRACT

An electronic apparatus may include a memory configured to store data related to a neural network model and at least one processor configured to divide a learning step performed through a plurality of layers of the neural network model into a plurality of steps including a forward propagation step, a gradient calculation step, and a derivative calculation step, and determine an execution order of the plurality of steps, obtain first information regarding in which step of a plurality of steps according to the determined execution order a plurality of sensors used in the plurality of layers are used, based on the determined execution order, integrate the determined execution order based on the first information and second information regarding whether tensors used in neighboring layers from among the plurality of layers are able to be shared, allocate the data to the plurality of tensors by minimizing a region of the memory for allocating data corresponding to the plurality of tensors, based on the integrated execution order, and train the neural network model according to the integrated execution order using the plurality of tensors and the data allocated to the plurality of tensors. Various other embodiments are possible to be implemented.

### CROSS-REFERENCE TO RELATED APPLICATIONS

This application is a continuation application of International Application No. PCT/KR2022/020897 designating the United States, filed on Dec. 20, 2022, in the Korean Intellectual Property Receiving Office and claiming priority to Korean Patent Application No. 10-2021-0185454, filed on Dec. 22, 2021, and Korean Patent Application No. 10-2022-0031573, filed on Mar. 14, 2022, in the Korean Intellectual Property Office, the disclosures of which are all hereby incorporated by reference herein in their entireties.

### BACKGROUND

### Technical Field

Certain example embodiments relate to an electronic apparatus and/or a controlling method thereof, and for example, to an electronic apparatus capable of training a neural network model and a controlling method thereof.

### Description of Related Art

Recently, with development of technologies related to artificial intelligence models, machine learning, and deep learning, various types of neural network models have been implemented within users' personal devices to provide various services to the users.

A neural network model can be trained on a server based on large amounts of data and vast resources, and then installed and operated on a user's device. However, there is a problem in that it is difficult to personalize the services according to the user's characteristics by training on the server alone. To solve this problem, it is possible to transmit the user's personal data to the server and retrain the neural network model, but if the user's personal data is transmitted to the server, it may be vulnerable to security and the user's privacy may be violated. In addition, personalizing the neural network for every user on the server requires significant service costs.

Therefore, in recent years, technologies related to efficiently training neural network models on-device within an individual user's terminal have been attracting people's attention. However, there are limitations in training neural network models on-device, such as limited computing resources and limited user data of the user terminal. Accordingly, technologies that can overcome these limitations are needed.

### SUMMARY

Certain example embodiments provide an electronic apparatus capable of significantly reducing memory usage in the process of training a neural network model and a controlling method thereof.

An electronic apparatus according to an example embodiment may include a memory configured to store data related to a neural network model and a processor configured to divide a learning step performed through a plurality of layers of the neural network model into a plurality of steps including a forward propagation step, a gradient calculation step, and a derivative calculation step, and determine an execution order of the plurality of steps, obtain first information regarding in which step of the plurality of steps according to the determined execution order a plurality of tensors used in the plurality of layers are used, based on the determined execution order, integrate the determined execution order based on the first information and second information regarding whether tensors used in neighboring layers from among the plurality of layers are able to be shared, allocate the data to the plurality of tensors by minimizing a region of the memory for allocating data corresponding to the plurality of tensors, based on the integrated execution order, and train the neural network model according to the integrated execution order using the plurality of tensors and the data allocated to the plurality of tensors.

The first information may be determined based on information regarding a type of step in which the plurality of tensors are used, from among the plurality of steps.

The type of step in which the plurality of tensors are used may include types indicating each of the forward propagation step, the gradient calculation step, the derivative calculation step, a backpropagation step including the gradient calculation step and the derivative calculation step, a step including the forward propagation step and the backpropagation step, and an overall learning step of the neural network model.

The second information may include first mode information indicating that tensors are in a pre-allocated state, second mode information indicating that a tensor needs to be newly created, third mode information indicating that data of a tensor is changed but the tensor is able to be shared with another tensor in an a neighboring layer, fourth mode information indicating that data of a tensor is unchanged and the tensor is able to be shared with the another tensor, and fifth mode information indicating that a tensor is able to be shared with all tensors.

The processor may be configured to, based on an execution order of a step in which a first tensor from among the plurality of tensors is last used being equal to or faster than an execution order in which a second tensor of a layer adjacent to a layer of the first tensor is first used, integrate at least a portion of the determined execution order so that the first tensor and the second tensor are shared.

The processor may be configured to, based on an execution order of a step in which a first tensor from among the plurality of tensors is last used being slower than an execution order of a step in which a second tensor of a layer adjacent to a layer of the first tensor is first used, if second information corresponding to the second tensor is the fourth mode information, integrate at least a portion of the determined execution order so that the first tensor and the second tensor are shared.

The processor may be configured to minimize a region of the memory by determining whether to further create a region of a memory for allocating data corresponding to the plurality of tensors or to overwrite a previously created region of memory, based on the integrated execution order.

A controlling method of an electronic apparatus according to an example embodiment may include dividing a learning step performed through a plurality of layers of the neural network model into a plurality of steps including a forward propagation step, a gradient calculation step, and a derivative calculation step, and determining an execution order of the plurality of steps, obtaining first information regarding in which step of a plurality of steps according to the determined execution order a plurality of tensors used in the plurality of layers are used, based on the determined execution order, integrating the determined execution order based on the first information and second information regarding whether tensors used in neighboring layers from among the plurality of layers are able to be shared, allocating the data to the plurality of tensors by minimizing a region of the memory for allocating data corresponding to the plurality of tensors, based on the integrated execution order, and training the neural network model according to the integrated execution order using the plurality of tensors and the data allocated to the plurality of tensors.

The first information may be determined based on information regarding a type of step in which the plurality of tensors are used, from among the plurality of steps.

The type of step in which the plurality of tensors are used may include types indicating each of the forward propagation step, the gradient calculation step, the derivative calculation step, a backpropagation step including the gradient calculation step and the derivative calculation step, a step including the forward propagation step and the backpropagation step, and an overall learning step of the neural network model.

The second information may include first mode information indicating that tensors are in a pre-allocated state, second mode information indicating that a tensor needs to be newly created, third mode information indicating that data of a tensor is changed but the tensor is able to be shared with another tensor in a neighboring layer, fourth mode information indicating that data of a tensor is unchanged and the tensor is able to be shared with the another tensor, and fifth mode information indicating that a tensor is able to be shared with all tensors.

The integrating the determined execution order may include, based on an execution order of a step in which a first tensor from among the plurality of tensors is last used being equal to or faster than an execution order in which a second tensor of a layer adjacent to a layer of the first tensor is first used, integrating at least a portion of the determined execution order so that the first tensor and the second tensor are shared.

The integrating the determined execution order may include, based on an execution order of a step in which a first tensor from among the plurality of tensors is last used being slower than an execution order of a step in which a second tensor of a layer adjacent to a layer of the first tensor is first used, if second information corresponding to the second tensor is the fourth mode information, integrating at least a portion of the determined execution order so that the first tensor and the second tensor are shared.

The allocating the data to the plurality of tensors may include minimizing a region of the memory by determining whether to further create a region of a memory for allocating data corresponding to the plurality of tensors or to overwrite a previously created region of memory, based on the integrated execution order.

According to an example embodiment, in a non-transitory computer readable recording medium including a program that executes a controlling method of an electronic apparatus, the controlling method of the electronic apparatus may include dividing a learning step performed through a plurality of layers of the neural network model into a plurality of steps including a forward propagation step, a gradient calculation step, and a derivative calculation step, and determining an execution order of the plurality of steps, obtaining first information regarding in which step of a plurality of steps according to the determined execution order a plurality of tensors used in the plurality of layers are used, based on the determined execution order, integrating the determined execution order based on the first information and second information regarding whether tensors used in neighboring layers from among the plurality of layers are able to be shared, allocating the data to the plurality of tensors by minimizing a region of the memory for allocating data corresponding to the plurality of tensors, based on the integrated execution order, and training the neural network model according to the integrated execution order using the plurality of tensors and the data allocated to the plurality of tensors.

### BRIEF DESCRIPTION OF DRAWINGS

FIG. 1 is a flowchart illustrating a controlling method of an electronic apparatus according to an example embodiment;

FIG. 2 is a view illustrating an execution order of a plurality of steps according to an example embodiment;

FIG. 3 is a view illustrating a type of step in which a plurality of tensors are used according to an example embodiment;

FIG. 4 is a view provided to explain a process of obtaining first information in detail according to an example embodiment;

FIG. 5 is a view illustrating mode information regarding a plurality of tensors according to an example embodiment;

FIG. 6 is a view provided to explain an example process of integrating an execution order determined based on first information and second information;

FIG. 7 is a view illustrating a method of allocating data to a tensor by minimizing a region of memory according to an example embodiment;

FIG. 8 is a view illustrating a method of allocating data to a tensor by minimizing a region of memory according to another example embodiment;

FIGS. 9 and 10 are views provided to explain a method of reducing data loading time according to an example embodiment;

FIG. 11 is a view provided to explain a method of adjusting the number of layers used in a computation step of a neural network model according to an example embodiment;

FIG. 12 is a block diagram illustrating configuration of an electronic apparatus briefly according to an example embodiment; and,

FIG. 13 is a block diagram illustrating configuration of an electronic apparatus in detail according to an example embodiment.

### DETAILED DESCRIPTION

Since the disclosure may be variously modified and have several exemplary embodiments, specific exemplary embodiments of the disclosure will be illustrated in the drawings and be described in detail in the detailed description. However, it is to be understood that the disclosure are not limited to specific exemplary embodiments, but include all modifications, equivalents, and substitutions according to exemplary embodiments of the disclosure. Throughout the accompanying drawings, similar components will be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope and spirit of the disclosure are not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular forms are intended to include plural forms unless the context clearly indicates otherwise.

In the disclosure, the expressions “have”, “may have”, “include” and or “may include” used herein indicate existence of corresponding features (e.g., elements such as numeric values, functions, operations, or components) but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1^{st},” “2^{nd},” or the like, used in the disclosure may indicate various components regardless of sequence and/or importance of the components, will be used only in order to distinguish one component from the other components, and do not limit the corresponding components

When it is described that an element (e.g., a first element) is referred to as being “(operatively or communicatively) coupled with/to” or “connected to” another element (e.g., a second element), it should be understood that it may be directly coupled with/to or connected to the other element or an intervening element(s) (e.g., a third element) may be present therebetween. In contrast, when an element (e.g., a first element) is referred to as being “directly coupled with/to” or “directly connected to” another element (e.g., a second element), it should be understood that there are no intervening element (e.g., a third element).

On the other hand, when it is described that an element (e.g., first element) is “directly coupled with/to” or “directly connected to” another element (e.g., second element), it may be understood that no element (e.g., third element) may exist between the element and the other element.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that the apparatus “is capable of” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory apparatus.

In exemplary embodiments, a “module” or a “unit” may perform at least one function or operation, and be implemented by hardware or software or be implemented by a combination of hardware and software. In addition, a plurality of “modules” or a plurality of “units” may be integrated in at least one module and be implemented by at least one processor except for a ‘module’ or a ‘unit’ that needs to be implemented by specific hardware. Thus, each “module” herein may comprise circuitry.

Meanwhile, various elements and regions in the drawings are schematically drawn. Therefore, the technical concept of the disclosure is not limited by a relative size or spacing drawn in the accompanying drawings.

Hereinafter, an embodiment according to the present disclosure will be described in detail with reference to the accompanying drawings so that those skilled in the art can easily implement it.

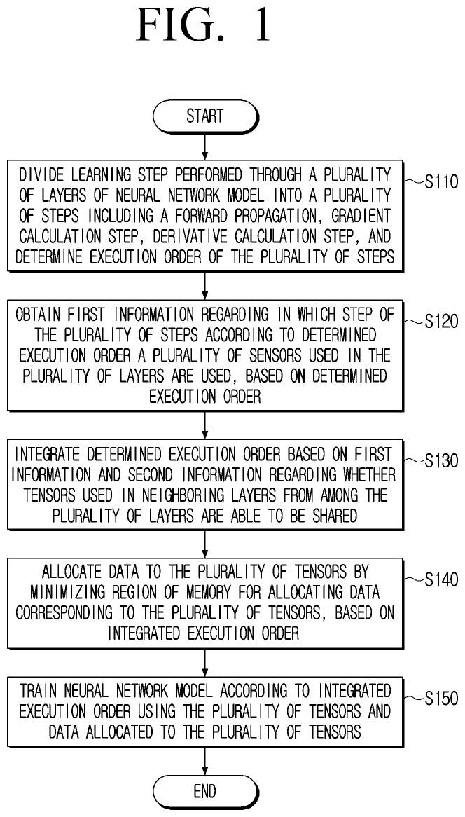

FIG. 1 is a flowchart illustrating a controlling method of an electronic apparatus according to an embodiment.

An electronic apparatus 100 according to an embodiment refers to an apparatus capable of training a neural network model. For example, the electronic apparatus 100 may be a user terminal or a server, such as a smartphone, a tablet PC, a smart watch, or the like. However, the type of electronic apparatus 100 according an embodiment is not particularly limited. The training of the neural network model according to an embodiment may be performed on-device within the electronic apparatus 100, but is not limited thereto.

A neural network model according to an embodiment refers to an artificial intelligence model comprising an artificial neural network, which may be trained by deep learning. Specifically, the neural network model may include at least one artificial neural network from among a deep neural network (DNN), convolutional neural network (CNN), recurrent neural network (RNN), and generative adversarial networks (GAN). However, the neural network model according to an embodiment is not limited to the above embodiments.

Referring to FIG. 1, the electronic apparatus 100 may divide the learning steps performed through the plurality of layers of the neural network model into a plurality of steps, including a forward propagation step, a gradient calculation step, and a derivative calculation step, and determine the order of execution of the plurality of steps (S110).

Specifically, the learning step of a neural network model can be broadly categorized into a forward (feedforward) propagation step and a backpropagation step. Here, the forward step refers to the step where the input value is passed in a direction from the input layer to the output layer to obtain the output value, and the backpropagation step refers to the step where the gradient is passed in a direction from the output layer to the input layer to update the weights of each layer.

The backpropagation process may include a gradient calculation step and a derivative calculation step. The gradient calculation step refers to a step of calculating the gradient to be used for updating the weights of each layer included in the neural network model, and the derivative calculation step refers to a step of calculating the derivative of the activation function of each layer.

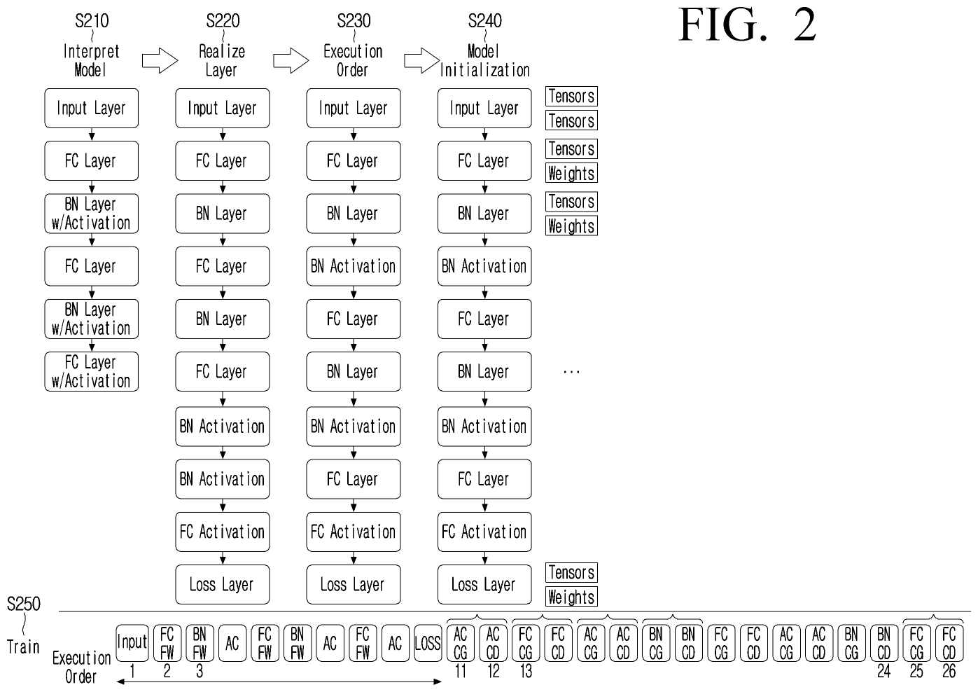

FIG. 2 is a view illustrating an execution order of a plurality of steps according to an embodiment. Referring to FIG. 2, training of a neural network model may include a model interpretation step S210 to interpret a plurality of layers included in the neural network model, a realization step S220 to embody the plurality of layers, an execution order determination step S230 to determine an execution order of the plurality of layers, a model initialization step S240 to allocate tensors to a plurality of layers, and a learning performance step S250 to perform learning based on the initialized model.

The bottom of FIG. 2 illustrates each learning step for each of the plurality of layers performed in the learning performance step S250. Here, FC is an abbreviation for fully connected, FW is for forward, BN is for batch normalization, AC is for activation, CG is for compute gradient, and CD is for compute derivative. In addition, numbers such as 1, 2, 3, 11, 12, 13, 24, 25, 26, etc. indicate the order of execution, and only the order of execution of some steps is shown for convenience. In particular, in the bottom of FIG. 2, the backpropagation step corresponding to one of the steps of the forward propagation step is divided into a gradient calculation step and a derivative calculation step. For example, the steps corresponding to execution orders 11 and 12 indicate a gradient calculation step and a derivative calculation step corresponding to one activation.

As described above with reference to FIG. 2, in the present disclosure, the learning steps performed through the plurality of layers of the neural network model are not simply divided into the forward propagation step and the backpropagation step, but may be further divided into the gradient calculation step and the derivative calculation step as the backpropagation step is further divided. In addition, the execution order may be determined for each subdivided step. Hereinafter, the term “plurality of steps” refers to the steps included in the entire learning step of the neural network model as shown at the bottom of FIG. 2, and the term “execution order” refers to the execution order allocated to each of the plurality of steps.

Meanwhile, the type of layers and the order of execution as shown in FIG. 2 are exemplary, and layers other than those shown in FIG. 2 may be included in the neural network model, and the backpropagation step may be further divided than shown in FIG. 2, and the execution order may be allocated.

Once the execution order of the plurality of steps is determined, the electronic apparatus 100 may obtain first information regarding in which of the plurality of steps in the execution order a plurality of tensors used in the plurality of layers are used, based on the determined execution order (S120).

In the present disclosure, a tensor is term collectively referring to input and output data, weights, gradients, derivatives, and the like used in a neural network model. In particular, a tensor may be distinguished into a specification part, which may include information regarding dimensions, information regarding the order of execution according to an embodiment, information regarding the type of steps and modes in which a plurality of tensors are used, and a data part, which indicates data allocated to the specification of the tensor. The embodiments described below include a process of defining a specification of a tensor and a process of allocating data to the specification of the tensor.

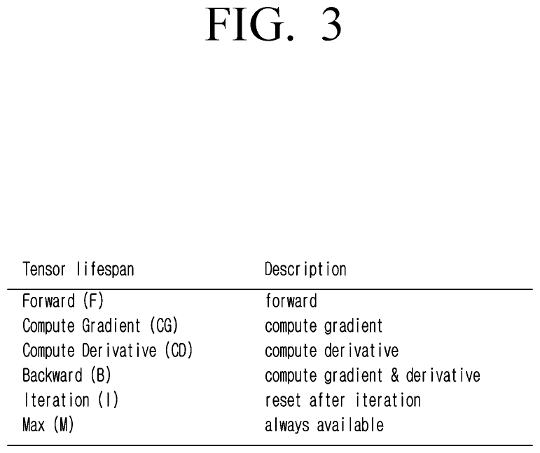

The first information may be determined based on information regarding the type of step in which the plurality of tensors are used from among the plurality of steps. Here, the type of step in which the plurality of tensors are used may include a type indicating a forward step (forward, F), a gradient computation step (compute gradient, CG) and a derivative computation step (compute derivative, CD), a backpropagation step (backward, B) including a gradient computation step and a derivative computation step, an iteration step (iteration, I) including a forward step and a backpropagation step, and an overall learning step (Max, M) of the neural network model, as shown in FIG. 3.

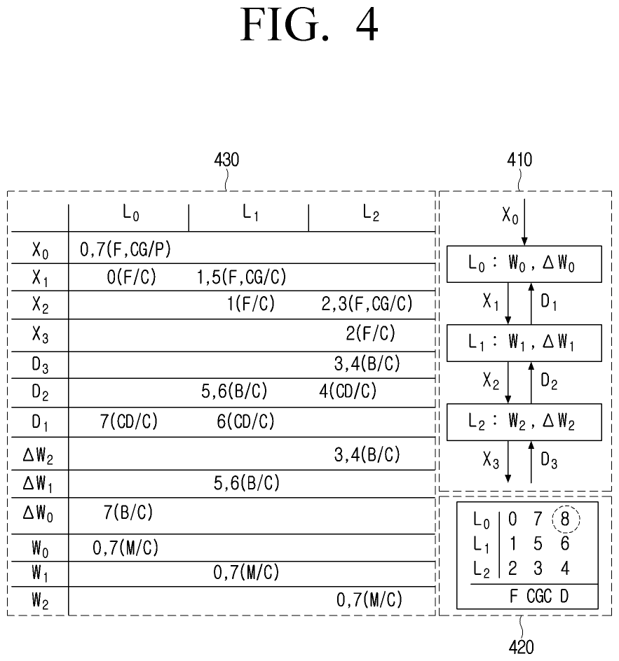

Hereinafter, step S120 will be described in detail with reference to FIG. 4. In other words, FIG. 4 is a view illustrating in detail a process of obtaining first information regarding in which of a plurality of steps in a determined execution order a plurality of tensors are used. For convenience of explanation, FIG. 4 assumes that a neural network model includes only three layers.

In FIG. 4, Ln denotes a layer, Xn denotes an input-output tensor, Dn denotes a derivative, AWn denotes a gradient, and Wn denotes a weight. In other words, the upper right FIG. 410 of FIG. 4 depicts the input-output tensor, derivative, gradient, and weight corresponding to each of the three layers L₀, L₁, and L₂ included in the neural network model.

Meanwhile, the bottom right FIG. 420 of FIG. 4 illustrates the steps performed through each layer and their execution order. Specifically, according to the embodiment of FIG. 4, the learning steps of the neural network model may be performed in the order of forward propagation through layer L₀ (execution order 0), forward propagation through layer L₁ (execution order 1), forward propagation through layer L₂ (execution order 2), and gradient computation through layer L₂ (execution order 3), derivative calculation step through layer L₂ (execution order 4), gradient calculation step through layer L₁ (execution order 5), derivative calculation step through layer L₁ (execution order 6), and gradient calculation step through layer L₀ (execution order 7). In FIG. 4, a dotted circle is shown in execution order 8, which indicates that the step of calculating the derivative through layer L₀ is not required.

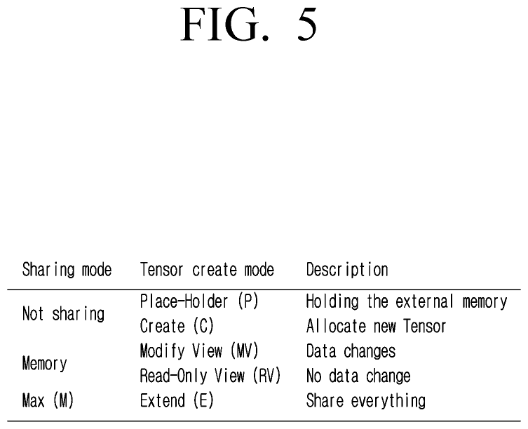

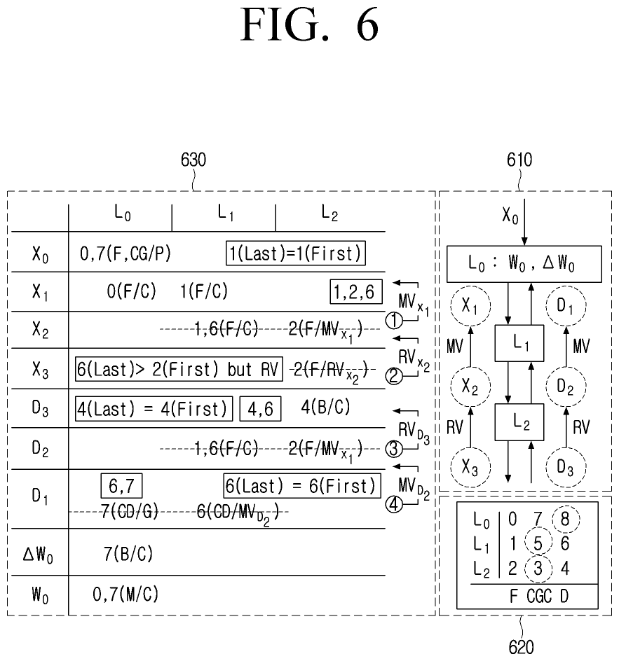

The left FIG. 430 of FIG. 4 illustrates a method of obtaining first information regarding in which of the plurality of steps in the determined execution order the plurality of tensors are used, when the execution order of the plurality of steps is determined, as shown in the rear bottom FIG. 420 of FIG. 4. In the left FIG. 430 of FIG. 4, the number in the row corresponding to each tensor indicates the execution order, and the information in parentheses indicates information regarding the type of step in which the plurality of tensors are used (before the slash in the parentheses) and the mode information corresponding to the tensors (after the slash in the parentheses), respectively. The mode information corresponding to the tensors is described below with reference to FIGS. 5 and 6.

For example, based on the fact that tensor X₀ is used in the forward propagation step performed in layer L₀ and the gradient calculation step performed in layer L₀, electronic apparatus 100 may obtain first information indicating that tensor X₀ is used in the steps corresponding to execution order 0 and execution order 7, respectively. In other words, in the FIG. 430 of FIGS. 4, 0 and 7 are written in the row corresponding to tensor X₀ to indicate that tensor X₀ is used in the steps corresponding to execution order 0 and execution order 7, respectively. The steps in which tensor X₁, tensor X₂, and tensor X₃ are used may also be determined in a similar manner to determining the steps in which tensor X₀ is used.

Further, the electronic apparatus 100 may obtain first information indicating that, based on the fact that tensor D₃ is used in the backpropagation step performed in layer L₂, tensor D₃ is used in the steps corresponding to execution order 2 and execution order 3, respectively. The steps in which tensor D₂ and tensor D₁ are used may also be determined in the same manner as determining the steps in which tensor D₃ is used.

In addition, based on the fact that tensor ΔW₂ is used in the backpropagation step performed in layer L₂, electronic apparatus 100 may obtain first information indicating that tensor ΔW₂ is used in the steps corresponding to execution order 3 and execution order 4, respectively. The steps in which tensor ΔW₁ and tensor ΔW₀ are used may also be determined in the same manner as determining the steps in which tensor ΔW₂ is used.

Further, based on the fact that the tensor W₀ must be maintained during the entire learning step of the neural network model performed in layer L₀ the electronic apparatus 100 may obtain first information indicating that the tensor W₀ is used in the steps corresponding to execution order 0 and execution order 7, respectively. The steps in which tensor W₁ and tensor W₂ are used may also be determined in the same manner as determining the steps in which tensor W₀ is used.

Once the first information is obtained, the electronic apparatus 100 may integrate the determined execution order based on the first information and second information regarding whether tensors used in neighboring layers of the plurality of layers can be shared (S130).

Here, as shown in FIG. 5, the second information may include first mode information (place-holder, P) indicating that the tensor has already been created, second mode information (create, C) indicating that the tensor needs to be newly created, third mode information (modify view, MV) indicating that the data of the tensor is changed but the tensor can be shared with other tensors in neighboring layers, fourth mode information (read-only view, RV) indicating that the tensor can be shared with other tensors because the data of the tensor is unchanged, and fifth mode information (extend, E) indicating that the tensor can be shared with all tensors.

Specifically, the first mode information and the second mode information indicate that the tensor cannot be shared with other tensors, while the third mode information, the fourth mode information, and the fifth mode information indicate that the tensor can be shared with other tensors. Which of the first to fifth mode information corresponds to mode information corresponding to a particular tensor may be determined by the electronic apparatus 100, or may be set by a developer or a user.

Hereinafter, step S130 will be described in detail with reference to FIG. 6. In other words, FIG. 6 is a view provided to explain a process of integrating an execution order determined based on first information and second information. As in the case of FIG. 4, the description of FIG. 6 also assumes that a neural network model includes three layers for convenience of explanation.

As in the case of FIG. 4, in FIG. 6, Ln refers to a layer, Xn refers to an input-output tensor, Dn refers to a derivative, ΔWn refers to a gradient, and Wn refers to a weight. In other words, the upper right FIG. 610 of FIG. 6 depicts the input-output tensor, derivative, gradient, and weight corresponding to each of the three layers L₀, L₁, and L₂ included in the neural network model (MV, RV will be described later).

Meanwhile, the bottom right FIG. 620 of FIG. 6 illustrates the steps performed through each layer and their execution order. Specifically, according to the embodiment of FIG. 6, the learning steps of the neural network model may be performed in the order of forward propagation through layer L₀ (execution order 0), forward propagation through layer L₁ (execution order 1), forward propagation through layer L₂ (execution order 2), a derivative calculation step through layer L₂ (execution order 4), a derivative calculation step through layer L₁ (execution order 6), and a gradient calculation step through layer L₀ (execution order 7). In FIG. 4, a dotted circle is shown for execution order 3, execution order 5, and execution order 8, indicating that the step of calculating the gradient through layer L₂, the step of calculating the gradient through layer L₁, and the step of calculating the derivative through layer L₀ are not required.

The left FIG. 630 of FIG. 6 illustrates a method of, when the execution order of a plurality of steps is determined, obtaining first information regarding in which of the plurality of steps in the determined execution order a plurality of tensors are used, and integrating the determined execution order as shown in the rear bottom FIG. 620 of FIG. 6. As in the case of FIG. 4, in FIG. 6 left FIG. 630, the number in the row corresponding to each tensor indicates the execution order, and the information in parentheses indicates information regarding the type of step in which the plurality of tensors are used (before the slash in the parentheses) and mode information corresponding to the tensors (after the slash in the parentheses), respectively.

For example, as shown in FIG. 6, the electronic apparatus 100 may obtain first information indicating that tensor X₀ is used in the steps corresponding to each of execution order 0 and execution order 7, that the tensor X₁ is used in the steps corresponding to each of execution order 0 and execution order 1, that the tensor X₂ is used in the steps corresponding to each of execution order 1, execution order 2, and execution order 6, and the like. The description of D₃, D₂, D₁, ΔW₀ and W₀ is omitted.

According to an embodiment, if the execution order of a step in which the first tensor from among the plurality of tensors is last used is equal to or faster than the execution order of a step in which the second tensor of a layer adjacent to a layer of the first tensor is first used, the electronic apparatus 100 may integrate at least a portion of the determined execution order so that the first tensor and the second tensor are shared.

Referring to the embodiment of FIG. 6, if the execution order of the step in which tensor X₁ is last used is no later than the execution order of the step in which tensor X₂ is first used, the electronic apparatus 100 may integrate the execution order so that tensor X₁ and tensor X₂ are shared. Specifically, since the step in which tensor X₁ is last used corresponds to execution order 1 and the step in which tensor X₂ is first used corresponds to execution order 1, tensor X₂ does not need to be further defined and X₁ can be used as it is. Therefore, it may be determined that tensors X₁ and X₂ are shared and tensor X₁ is used for steps corresponding to execution order 0, execution order 1, execution order 2, and execution order 6, respectively. In FIG. 6, the mode information corresponding to tensor X₂ is described as third mode information (modify view, MV), which indicates that the data of tensor X₁ is changed but tensor X₂ can be shared with X₁, another tensor in neighboring layers, based on the execution order.

According to an embodiment, even if the execution order of a step in which the first tensor from among the plurality of tensors is last used is slower than the execution order of a step in which the second tensor of a layer adjacent to a layer of the first tensor is first used, when second information corresponding to the second tensor is fourth mode information, the electronic apparatus 100 may integrate at least a portion of the determined execution order so that the first tensor and the second tensor are shared.

Referring to the embodiment of FIG. 6, even if the execution order of a step in which tensor X₂ is last used is slower than the execution order of a step in which tensor X₃ is first used, the electronic apparatus 100 may integrate the execution order so that tensor X₂ and tensor X₃ are shared. Specifically, even if the step in which tensor X₂ is last used corresponds to execution order 6, and the step in which tensor X₃ is first used corresponds to execution order 2, because the mode information corresponding to tensor X₃ is fourth mode information (read-only view, RV), that is, the mode information indicating that the data of tensor X₂ is unchanged and thus, tensor X₃ can be integrated with X₂, another tensor, in neighboring layers, the electronic apparatus 100 may integrate the execution order so that so that tensor X₂ and tensor X₃ are shared.

While only tensor X₁, tensor X₂, and tensor X₃ have been described above, as shown in FIG. 6, sharing of tensors and integration of execution order can also be achieved among tensor D₃, tensor D₂, and tensor D₃ in the same manner as described for tensor X₁, tensor X₂, and tensor X₃.

Meanwhile, although the above describes sharing of tensors and integration of execution order with reference to the embodiment of FIG. 6, sharing of tensors and integration of execution order may not be made when sharing of tensors and integration of execution order cannot be made as in the embodiment of FIG. 4 (when the second information corresponding to all the tensors is first mode information or second mode information). In other words, step S130 according to an embodiment may not be performed according to the embodiment. In light of this, hereinafter, integration of the execution order of a plurality of steps may include not only cases where sharing of tensors and integration of execution order according to step S130 is performed, but also cases where sharing of tensors and integration of execution order is considered but not performed.

When the execution order of the plurality of steps is integrated, the electronic apparatus 100 may allocate data to the plurality of tensors by minimizing a region of memory for allocating data to the plurality of tensors, based on the integrated execution order (S140).

Specifically, the electronic apparatus 100 may minimize the region of memory by determining, based on the integrated execution order, whether to create an additional region of memory for allocating data corresponding to the plurality of tensors or to overwrite a previously created region of memory.

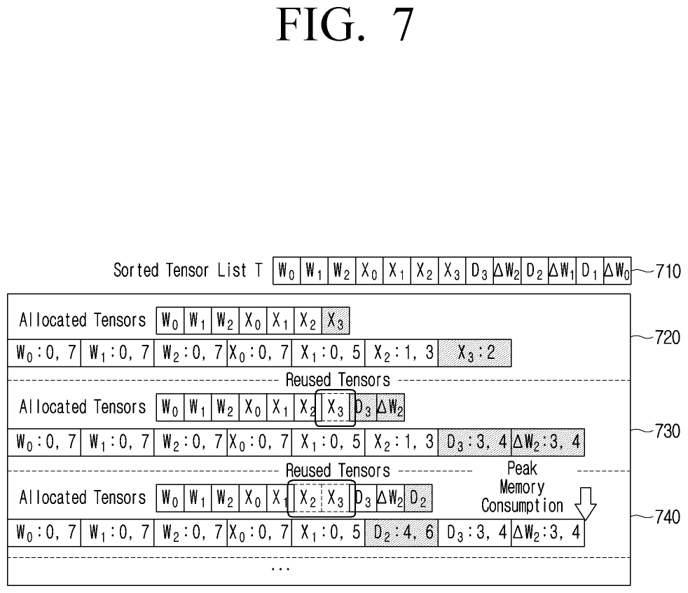

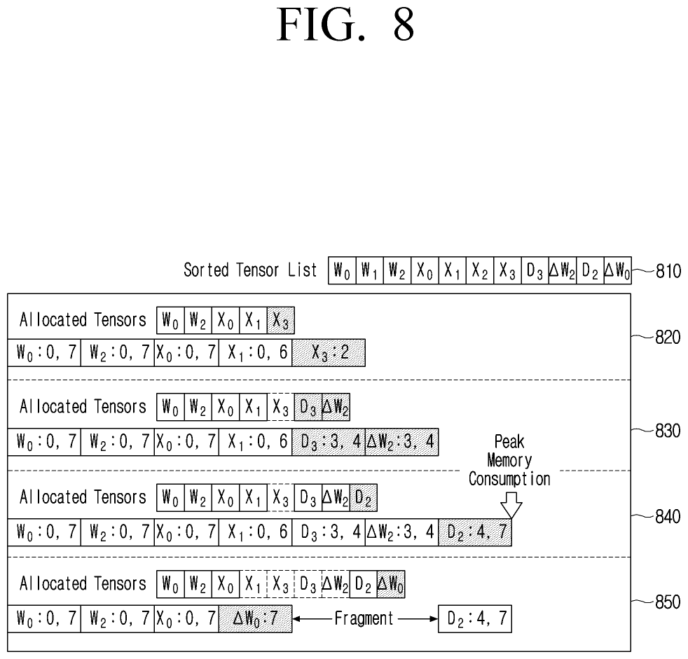

Hereinafter, a method of allocating data to tensors by minimizing a region of memory will be described in detail with reference to FIGS. 7 and 8. FIG. 7 illustrates a method of allocating data to tensors by minimizing a region of memory when a plurality of tensors are used in a plurality of layers and the order of execution of the plurality of steps is finally determined according to the embodiment of FIG. 4, and FIG. 8 illustrates a method of allocating data to tensors by minimizing a region of memory when a plurality of tensors are used in a plurality of layers and the order of execution of the plurality of steps is finally determined according to the embodiment of FIG. 6.

FIG. 710 of FIG. 7 sequentially illustrates tensors used in the plurality of layers for the embodiment of FIG. 4. In addition, FIGS. 720, 730, and 740 illustrate a method of minimizing a region of memory in the process of allocating data to the tensors used in the plurality of layers.

Referring to FIG. 720, since tensor W₀ is used for steps corresponding to execution order 0 and execution order 7, respectively, and tensor W₁ is used for steps corresponding to execution order 0 and execution order 7, respectively, data corresponding to tensor W₁ cannot be overwritten in the region of memory corresponding to tensor W₀. Therefore, electronic apparatus 100 may further allocate the region of memory corresponding to tensor W₁. In other words, since tensor W₀ must ensure validity not only in the step corresponding to execution order 0, but also in the step corresponding to execution order 7, data corresponding to tensor W₁ cannot be overwritten in the region of memory corresponding to tensor W₀, and therefore an additional region of memory corresponding to tensor W₁ must be allocated. For the same reason, additional regions of memory corresponding to tensor W₂, tensor X₀, tensor X₁, tensor X₂, and tensor X₃ are further allocated.

In the previous embodiment, when considering a region of memory to allocate data corresponding to tensor W₁, only whether the region of memory corresponding to W₀ could be overwritten is considered, but when considering a region of memory to allocate data corresponding to tensor W₂, whether not only the region of memory corresponding to tensor W₁ but also the region of memory corresponding to tensor W₀ could be overwritten by data corresponding to tensor W₂ can be considered.

Referring to FIG. 730, since tensor X₃ is used in the step corresponding to execution order 2 and tensor D₃ is used in the step corresponding to each of execution order 3 and execution order 4, data corresponding to tensor D₃ can be overwritten in the region of memory corresponding to tensor X₃. Thus, the electronic apparatus 100 may use the region of memory corresponding to the tensor X₃ without further allocating the region of memory corresponding to the tensor D₃. In FIG. 730, the indication of tensor X₃ being reused is that the region of memory corresponding to tensor X₃ may be used to allocate data to tensor D₃.

Meanwhile, since tensor D₃ is used in the steps corresponding to execution order 3 and execution order 4, respectively, and tensor ΔW₂ is also used in the steps corresponding to execution order 3 and execution order 4, respectively, the region of memory corresponding to tensor ΔW₂ is further allocated.

Referring to FIG. 740, since tensor X₂ only needs to ensure validity until steps corresponding to execution order 1 and execution order 3, respectively, and tensor D₂ is used in the steps corresponding to execution order 4 and execution order 6, respectively, data corresponding to tensor D₂ can be overwritten in the region of memory corresponding to tensor X₂. Thus, the electronic apparatus 100 may use the region of memory corresponding to the tensor X₂ without further allocating the region of memory corresponding to the tensor D₃. In FIG. 740, the indication of tensor X₂ being reused is that the region of memory corresponding to tensor X₂ may be used to allocate data to tensor D₂.

Meanwhile, the peak memory consumption in FIG. 7 indicates a threshold of memory capacity allowed to allocate data to the tensors, which may vary depending on the specification of the memory and the settings of the user/developer. In FIG. 730, if an additional region of memory corresponding to each of tensor D₃ and tensor ΔW₂ is further allocated, the peak memory consumption according to the embodiment of FIG. 7 is reached. Therefore, the electronic apparatus 100 may allocate data based on whether data corresponding to tensor D₃ and data corresponding to tensor D₂ can be overwritten in the previously allocated region of memory corresponding to tensor X₃ and the previously allocated region of memory corresponding to tensor X₂. However, it is also possible to use the region of memory corresponding to the previously allocated tensor even if the peak memory consumption is not reached in the process of allocating data to the tensors.

FIG. 810 of FIG. 8 sequentially illustrates the tensors used in the plurality of layers for the embodiment of FIG. 6. In addition, FIGS. 820, 830, and 840 illustrate methods of minimizing the region of memory during the process of allocating data to the tensors used in the plurality of layers.

Referring to FIG. 820, since tensor W₀ is used for steps corresponding to execution order 0 and execution order 7, respectively, and tensor W₁ is used for steps corresponding to execution order 0 and execution order 7, data corresponding to tensor W₁ cannot be overwritten in the region of memory corresponding to tensor W₀. Therefore, electronic apparatus 100 may further allocate the region of memory corresponding to tensor W₁. For the same reason, regions of memory corresponding to tensor W₂, tensor X₀, tensor X₁, and tensor X₃ are further allocated. Here, the omission of tensor X₂ is due to the process of sharing of tensors and integration of execution order as described above with reference to FIG. 6.

Referring to FIG. 830, since tensor X₃ is used in the step corresponding to execution order 2 and tensor D₃ is used in the steps corresponding to each of execution order 3 and execution order 4, data corresponding to tensor D₃ can be overwritten in the region of memory corresponding to tensor X₃. Therefore, the electronic apparatus 100 may use the region of memory corresponding to the tensor X₃ without further allocating the region of memory corresponding to tensor D₃. Meanwhile, tensor ΔW₂ is used in the steps corresponding to execution order 3 and execution order 4, respectively, and since there is no region of memory that can overwrite tensor ΔW₂ among the previously allocated regions, the region of memory corresponding to tensor ΔW₂ is further allocated.

Referring to FIG. 840, tensor D₂ is used in the steps corresponding to execution order 4 and execution order 7, respectively, and since there is no region of the pre-allocated memory that can overwrite tensor D₂, the region of memory corresponding to tensor D₂ is further allocated.

Referring to FIG. 850, tensor ΔW₀ is used in the step corresponding to execution order 7, and since tensor T₁, tensor T₂, tensor D₃, and tensor ΔW₂ all ensure validity only until the step corresponding to execution order 7, tensor ΔW₀ can overwrite the region of memory corresponding to tensor T₁, tensor T₂, tensor D₃, or tensor ΔW₂. Therefore, the electronic apparatus 100 may use the region of memory corresponding to tensor T₁, tensor T₂, tensor D₃, or tensor ΔW₂ without further allocating a region of memory corresponding to tensor ΔW₂ and tensor ΔW₀. Accordingly, there is a fragment between the region of memory corresponding to tensor ΔW₂ and the region of memory corresponding to tensor D₂.

After steps S110 through S140 as described above are performed, the electronic apparatus 100 may train the neural network model according to the integrated execution order using the plurality of tensors and data allocated to the plurality of tensors (S150).

Specifically, once the plurality of tensors and the data allocated to the plurality of tensors are defined according to the execution order of the plurality of steps as described above, the electronic apparatus 100 may update the weights of each of the plurality of layers of the neural network model by training the neural network model according to the integrated execution order using the plurality of tensors and the data allocated to the plurality of tensors.

In particular, when a neural network model according to an embodiment is pre-trained by a server and then re-trained by the electronic apparatus 100 according to an embodiment, the neural network model may be personalized to a user of the electronic apparatus 100 based on the learning results as described above.

According to the embodiment described above with reference to FIGS. 1 to 7, the electronic apparatus 100 is able to minimize the use of memory by efficiently defining the plurality of tensors and the data allocated to the plurality of tensors according to the execution order of the plurality of steps. Accordingly, the training of the neural network model for personalization can be efficiently performed, in particular on-device, without overhead.

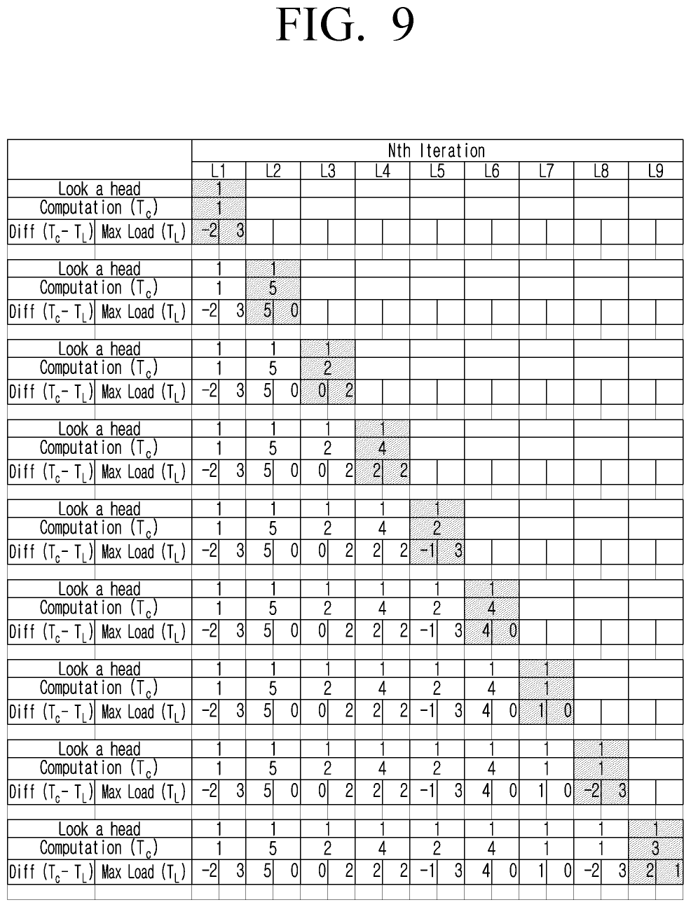

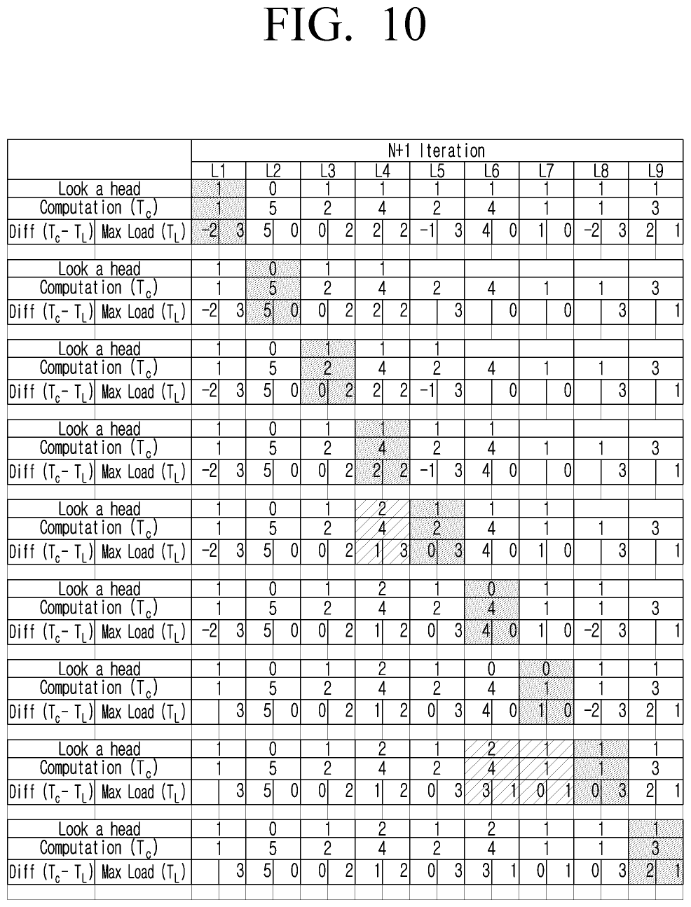

FIGS. 9 and 10 are views provided to explain a method of reducing data loading time according to an embodiment.

Loading time may refer to the time required to load data required to perform training of a neural network model from non-volatile memory, such as flash memory, embedded multimedia card (eMMC), or the like, into volatile memory, such as random access memory (RAM) or a global buffer included in a processor. However, there are no specific restrictions on which type of storage can be used to load data from which type of storage.

FIG. 9 illustrates information obtained when performing the nth iteration of training a neural network model, and FIG. 10 illustrates information obtained when performing the n+1st iteration of training a neural network model. The following description assumes that the nth iteration of FIG. 9 is the first iteration and the n+1st iteration is the second iteration.

In FIGS. 9 and 10, L₁ to L₀ indicate each of the nine layers included in the neural network model. In addition, the term ‘look a head’ refers to the index information indicating how many steps to consider in advance in each layer. For example, if the look a head of the first layer is 1, the computation of the first layer considers only the computation time spent in the first layer and the maximum or high loading time of the data; if the look a head of the second layer is 2, the computation of the second layer considers not only the computation time spent in the second layer and the maximum or high loading time of the data but also the computation time spent in the next layer, the third layer, and the maximum or high loading time of the data.

In FIGS. 9 and 10, computation (T_{C}) indicates the computation time for each layer, and max load (T_{L}) indicates the maximum or a high loading time of data for each layer. In addition, diff (T_{C}-T_{L}) indicates the computation time of each layer minus the maximum loading time of the data of each layer. In other words, if diff is negative, the maximum loading time of the data is longer than the computation time of the corresponding layer, so you need to wait for loading. Conversely, if diff is positive, it means that the maximum loading time of the data is less than the computation time of the corresponding layer, so there is no need to wait for loading and there is time that can be allocated for additional data loading.

Referring to FIG. 9, while performing the first iteration, the electronic apparatus 100 may first set look a head to 1 and then calculate the computation time for each layer (T_{C}), the maximum loading time of the data for each layer (T_{L}), and the computation time for each layer minus the maximum loading time of the data for each layer (diff).

For example, based solely on the computation time spent in layer L₁ and the maximum loading time of data, the electronic apparatus 100 may obtain information that the computation time of layer L₁ is 1 and the maximum loading time is 3, and accordingly, the difference between the computation time and the maximum loading time is −2. This means that if you perform a computation on layer L₁, you have to wait for the data to load by a time corresponding to 2.

In addition, the electronic apparatus 100 may obtain information that, based solely on the computation time spent in layer L₂ and the maximum loading time of the data, the computation time of layer L₂ is 5 and the maximum loading time is 0 (e.g., when using already loaded data), and thus the difference between the computation time and the maximum loading time is 5. This means that if we perform the computation on layer L₂, we can spend 5 hours loading the data.

Further, the electronic apparatus 100 may perform computation on layer L₃ to layer L₀ in the same manner as for layer L₁ and layer L₂ to calculate the computation time for each layer, the maximum loading time, and the difference between the computation time and the maximum loading time.

Referring to FIG. 10, the electronic apparatus 100 may update the look a head while performing the second iteration to ensure that the difference between the computation time and the maximum loading time is zero or positive. Specifically, if there is a layer that has a negative diff value as a result of performing the first iteration, the overall loading latency can be reduced by performing pre-loading in the layer where a diff value is positive from among the layers preceding the corresponding layer.

For example, starting with the description of layer L₂ and providing the description of layer L₁ later, since the diff value is positive for layer L₂ to layer L₄, there is no need to perform pre-loading in the preceding layers to reduce the loading latency of layer L₂ to layer L₄. This is also true for layer L₀, layer L₇, and layer L₉.

However, since layer L₅ has a diff value of −1, it may be desirable to perform pre-loading in the preceding layer by a time corresponding to 1. Therefore, the electronic apparatus 100 may adjust the look a head of layer L₄ to 2, and increase the maximum loading time by 1 to adjust it to 3. As a result, there is still no loading time delay in layer L₄ because the diff value of layer L₄ is still greater than 0, and there is also no loading time delay in layer L₅ because the diff value of layer L₅ is adjusted to 0.

Meanwhile, since layer L₈ has a diff value of −2, it is desirable to perform pre-loading in the preceding layer by a time corresponding to 2. Therefore, the electronic apparatus 100 may adjust the look a head of layer L₇ to 1 and increase the maximum loading time by 1 to adjust it to 1. As a result, since the diff value of layer L₇ is still greater than 0, which is the case where the diff value of layer L₅ decreases from −2 to −1, but there is still a loading time delay. Therefore, the electronic apparatus 100 may adjust the look a head of layer L₆ to 2, and may adjust the maximum loading time to 1 by increasing it by 1. As a result, there is still no loading time delay in layer L₀ because the diff value of layer L₆ is still greater than 0, and there is also no loading time delay in layer L₈ because the diff value of layer L₈ is adjusted to 0.

Meanwhile, in the above, the description of layer L₁ is omitted and the description starts with layer L₂, but the training of the neural network model is performed iteratively. Thus, the electronic apparatus 100 may perform the necessary loading of layer L₁ in advance while performing the computation step of layer L₀ in the same manner as the method described above.

As the number of iterations increases as described above while training the neural network model, the look a head value will converge to the optimized value for each layer, and the diff value for each layer can be adjusted to zero or positive.

According to the embodiment described above with reference to FIGS. 9 and 10, the electronic apparatus 100 may significantly reduce the data loading time spent on the entire layers by striking balance between the computation time for each of the plurality of layers and the data loading time, thereby minimizing the use of memory.

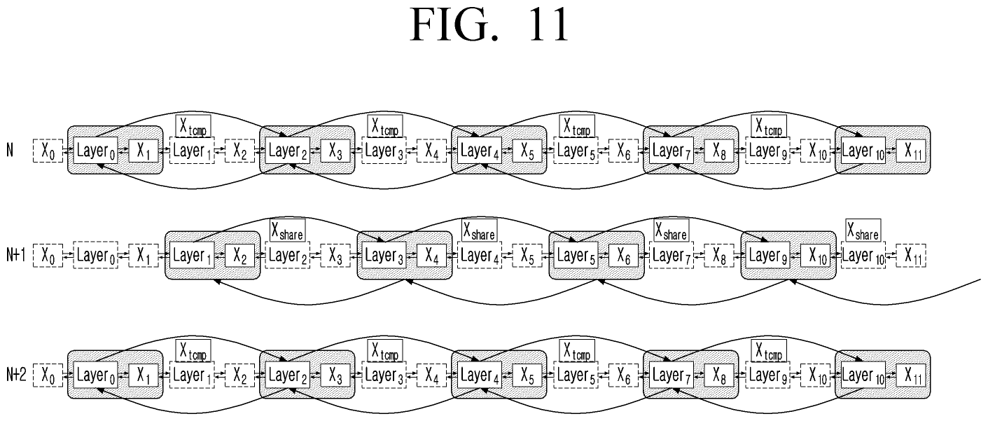

FIG. 11 is a view provided to explain a method of adjusting the number of layers used in a computation step of a neural network model according to an embodiment.

In FIGS. 11, N, N+1, and N+2 distinguish the number of iterations of the learning process, and the layers marked with solid lines indicate the layers used in the computation step, the layers marked with dotted lines indicate the layers not used in the computation step. Here, the computation step refers to the forward propagation step.

Specifically, layers that are used in the computation step are the ones that calculate the gradient and update the weights, and since the result values calculated from the forward propagation step are used to calculate the gradient, they need to be loaded into memory before the backpropagation step is performed. On the other hand, layers that are not used in the computation step do not update weights and are only used in the backpropagation step to calculate the derivative, so there is no need to load the result values calculated from the forward propagation step.

Specifically, in the Nth iteration, the electronic apparatus 100 may use only the odd numbered layers (layer₀, layer₂, layer₄, layer₇, layer₁₀ of FIG. 11) of the entire layers in the computation step. In this case, the even numbered layers (layer₁, layer₃, layers, layer₉ of FIG. 11) of the entire layers are not used in the computation step as described above, but they are used only in the step of calculating the derivative in the backpropagation step, thereby reducing memory usage.

In addition, since the training of the neural network model requires updating the weights of all layers, the electronic apparatus 100 may, at the N+1st iteration, may use only the even numbered layers (layer₁, layer₃, layers, layer₉ of FIG. 11) in the computation step, and use the odd numbered layers (layer₀, layer₂, layer₄, layer₇, layer₁₀ of FIG. 11) in the backpropagation step to calculate the derivative.

Further, the electronic apparatus 100, at the N+2 iteration, may use only the odd numbered layers (layer₀, layer₂, layer₄, layer₇, layer₁₀ of FIG. 11) of the entire layers in the computation step, and use the even numbered layers (layer₁, layer₃, layer₅, layer₉ of FIG. 11) of the entire layers in the back propagation step to compute the derivative.

Meanwhile, while the above describes an embodiment in which odd numbered layers and even numbered layers among the entire layers are separated and used for the computation step, the layers used for the computation step in each iteration may of course be selected differently from the embodiment of FIG. 11.

According to the embodiment described above with reference to FIG. 11, the electronic apparatus 100 may be able to train the neural network model while using memory in an effective manner. Meanwhile, if only some layers of the plurality of layers are used in each iteration, there may be a concern that the accuracy of the neural network model may decrease. However, according to an embodiment, in the next iteration, layers that were not used in the previous iteration can be included in the computation step. In addition, the present disclosure can be applied to the case where a neural network is trained by a server and then retrained by the electronic apparatus 100 for personalization. As a result, according to the embodiments described above, it is possible to minimize the use of memory without significantly reducing the accuracy of the neural network model.

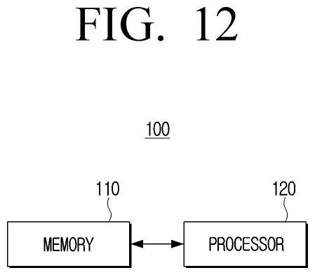

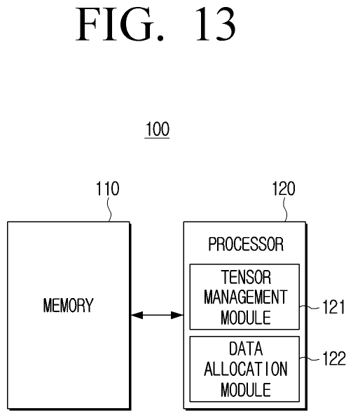

FIG. 12 is a block diagram illustrating configuration of the electronic apparatus 100 briefly according to an embodiment, and FIG. 13 is a block diagram illustrating configuration of the electronic apparatus 100 in detail according to an embodiment.

As shown in FIG. 12, the electronic apparatus 100 according to an embodiment includes the memory 110 and the processor 120.

The memory 110 may store at least one instruction for the electronic apparatus 100. Further, the memory 110 may store an operating system (O/S) for operating the electronic apparatus 100. The memory 110 may also store various software programs or applications for operating the electronic apparatus 100 in accordance with various embodiments. The memory 110 may include a semiconductor memory 110, such as a flash memory 100, or magnetic storage media, such as a hard disk.

Specifically, the memory 110 may store various software modules for operating the electronic apparatus 100 in accordance with various embodiments, and the processor 120 may execute the various software modules stored in the memory 110 to control the operation of the electronic apparatus 100. In other words, the memory 110 may be accessed by the processor 120, and reading/writing/modifying/deleting/updating of data by the processor 120 may be performed.

Meanwhile, the term ‘memory 110’ may be used in this disclosure to include the memory 110, a ROM (not shown), a RAM (not shown) in the processor 120, or a memory 110 card (not shown) (e.g., a micro SD card, memory stick) mounted in electronic apparatus 100.

In particular, in various embodiments, the memory 110 may store data related to a neural network model, specifically, information regarding layers of the neural network model and various parameters including weights. The memory 110 may also store a plurality of tensors according to an embodiment, data allocated to the plurality of tensors, and the like. Further, the memory 110 may store information regarding the order of execution of the plurality of steps determined, first information and second information according to an embodiment, information regarding the type of step for which the plurality of tensors are used, and the like.

In addition, various information may be stored in the memory 110 that is necessary to accomplish the purposes of various example embodiments, and the information stored in the memory 110 may be updated as it is received from a server or an external device or as it is entered by a user.

The processor 120 controls the overall operation of the electronic apparatus 100. Specifically, the processor 120 is associated with configuration of the electronic apparatus 100 that includes the memory 110 and may control the overall operation of the electronic apparatus 100 by executing at least one instruction stored in the memory 110, as described above.

The processor 120 may be implemented in various ways. For example, the processor 120 may be implemented as at least one of an Application Specific Integrated Circuit (ASIC), an embedded processor, a microprocessor, hardware control logic, a hardware Finite State Machine (FSM), and a Digital Signal Processor (DSP). In addition, the term ‘processor 120’ may be used in this disclosure to include a central processing unit (CPU), a graphics processing unit (GPU), and a main processing unit (MPU).

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In particular, in various embodiments, the processor 120 may divide a learning step performed by the plurality of layers of the neural network model into a plurality of steps including a forward propagation step, a gradient calculation step, and a derivative calculation step, determine an execution order of the plurality of steps, and, based on the determined execution order, obtain first information regarding in which of the plurality of steps according to the determined execution order a plurality of tensors used in the plurality of layers are used, integrate the determined execution order based on the first information and the second information regarding whether the tensors used in neighboring layers from among the plurality of layers can be shared; and, based on the integrated execution order, allocate data to the plurality of tensors by minimizing a region of the memory 110 for allocating data corresponding to the plurality of tensors, and train the neural network model according to the integrated execution order using the plurality of tensors and the data allocated to the plurality of tensors. Here, since the first information and the second information have been described above, a redundant description of the same will be omitted.

“Based on” as used herein covers based at least on.

According to an embodiment, if the execution order of a step in which the first tensor of the plurality of tensors is last used is equal to or faster than the execution order of a step in which the second tensor of a layer adjacent to a layer of the first tensor is first used, the processor 120 may integrate at least a portion of the determined execution order so that the first tensor and the second tensor are shard.

According to an embodiment, if the execution order of a step in which the first tensor of the plurality of tensors is last used is slower than the execution of a step in which the second tensor of a layer adjacent to a layer of the first tensor is first used, when the second information corresponding to the second tensor is fourth mode information, the processor 120 may integrate at least a portion of the determined execution order so that the first tensor and the second tenso are shared.

According to an embodiment, the processor 120 may minimize the region of the memory 110 by determining, based on the integrated execution order, whether to create additional regions of the memory 110 for allocating data corresponding to the plurality of tensors or to overwrite the previously created regions of the memory 110.

In addition, various embodiments as described above with reference to FIGS. 1 to 11 are equally applicable to the control process of the processor 120, and detailed redundant descriptions of the same are omitted.

Meanwhile, as shown in FIG. 13, the processor 120 may further include a tensor management module 121 and a data allocation module 122.

As described above, a tensor according to an embodiment can be distinguished into a specification portion, which includes information regarding dimensions, information regarding the execution order according to an embodiment, and information regarding the type of steps and modes in which the plurality of tensors are used, and a data portion, which indicates data allocated to the specification of the tensor. In addition, the embodiments described with reference to FIGS. 1 to 8 include a process of defining a specification of a tensor and a process of allocating data to the specification of the tensor.

The tensor management module 121 refers to a module that controls the process of defining the specification of tensors, and may be referred to as a tensor pool. Specifically, the tensor management module 121 may perform operations according to steps S110, S120, and S130 of FIG. 1.

The data allocation module 122 refers to a module that controls the process of allocating data to the specification of tensors, and may be referred to as a memory planner. Specifically, the data allocation module 122 may perform operations according to step S140 of FIG. 1.

While tensor management module 121 and data allocation module 122 have been described above as examples of modules included in processor 120, other modules corresponding to various operations according to an embodiment may be implemented in the form of hardware modules or software modules.

Meanwhile, functions related to the neural network model as described above may be performed through the memory 110 and the processor 120.

The processor 120 may consist of one or a plurality of processors 120. In this case, the one or plurality of processors 120 may be a general purpose processor 120, such as CPU, AP, or the like, a graphics-only processor 120, such as GPU, VPU, or the like, or an artificial intelligence-only processor 120, such as an NPU.

The one or more processors 120 are controlled to process the input data according to predefined operation rules or artificial intelligence models stored in the non-volatile memory 110 and the volatile memory 110. The predefined operation rules or artificial intelligence models are characterized as having been created through learning.

Here, created through learning indicates that by applying a learning algorithm to a plurality of training data, predefined operation rules or artificial intelligence models of desired characteristics are created. This learning can be performed on the device itself, where the artificial intelligence according to an embodiment is performed, or on a separate server/system.

An artificial intelligence model may consist of a plurality of neural network layers. Each layer has a plurality of weight values, and the computation of the layers is performed using the computation results of the previous layers and the computation of the plurality of weights. Examples of neural networks include convolutional neural networks (CNN), deep neural networks (DNN), recurrent neural networks (RNN), restricted Boltzmann machines (RBM), deep belief networks (DBN), bidirectional recurrent deep neural networks (BRDNN), generative adversarial networks (GAN), and deep Q-networks, but are not limited to the above-described examples, except where specified.

A learning algorithm is a method of training a target device (e.g., a robot) using multiple training data to enable the target device to make decisions or predictions on its own. Examples of learning algorithms include supervised learning, unsupervised learning, semi-supervised learning, or reinforcement learning, and the learning algorithms of this disclosure are not limited to the above-described examples, except where specified.

The device-readable storage medium may be provided in the form of a non-transitory storage medium. Here, ‘non-temporary storage medium’ only means that it is a tangible device and does not contain signals (e.g., electromagnetic waves). This term does not distinguish between a case in which data is stored semi-permanently in a storage medium and a case in which data is stored temporarily. For example, a ‘non-temporary storage medium’ may include a buffer in which data is temporarily stored.

According to an embodiment, the methods according to the various embodiments described above may be included and provided in a computer program product. The computer program product may be traded as a product between a seller and a purchaser. The computer program product can be distributed in the form of a storage medium that is readable by machines (e.g.: a compact disc read only memory (CD-ROM)), or distributed directly on-line (e.g.: download or upload) through an application store (e.g.: Play Store™), or between two user devices (e.g.: smartphones). In the case of on-line distribution, at least a portion of a computer program product (e.g.: a downloadable app) may be stored in a storage medium readable by machines such as the server of the manufacturer, the server of the application store, or the memory 110 of the relay server at least temporarily, or may be generated temporarily.

As described above, each of the components (e.g., modules or programs) according to the various embodiments may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before being integrated in the same or similar manner.

Operations performed by the modules, the programs or other components according to the various embodiments may be executed in a sequential manner, a parallel manner, an iterative manner or a heuristic manner, and at least some of the operations may be performed in a different order or be omitted, or other operations may be added.

Meanwhile, terms “˜er/or” or “module” used in the disclosure may include units configured by hardware, software, or firmware, and may be used compatibly with terms such as, for example, logics, logic blocks, components, circuits, or the like. The “˜er/or” or “module” may be an integrally configured component or a minimum unit performing one or more functions or a part thereof. For example, the module may be configured by an application-specific integrated circuit (ASIC).

Various embodiments may be implemented in software including an instruction stored in a machine-readable storage medium (e.g., computers). A machine may be a device that invokes the stored instruction from the storage medium and is operated based on the invoked instruction, and may include the electronic apparatus (e.g., electronic apparatus 100) according to embodiments disclosed herein.

In case that the instruction is executed by the processor, the processor may directly perform a function corresponding to the instruction or other components may perform the function corresponding to the instruction under control of the processor. The instruction may include codes provided or executed by a compiler or an interpreter. Hereinabove, the embodiments of the disclosure have been described but the disclosure is not limited to the specific embodiment and may be variously modified by a person skilled in the art to which the disclosure pertains without departing from the gist of the disclosure as claimed herein, and such modifications should not be individually understood from technical concepts or prospects of the disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic apparatus comprising:
a memory configured to store data related to a neural network model; and
at least one processor, comprising processing circuitry, individually and/or collectively configured to:
divide a learning step performed through a plurality of layers of the neural network model into a plurality of steps including a forward propagation step, a gradient calculation step, and a derivative calculation step, and determine an execution order of the plurality of steps;
obtain first information regarding in which step of the plurality of steps according to the determined execution order a plurality of tensors used in the plurality of layers are used, based on the determined execution order;
integrate the determined execution order based on the first information and second information regarding whether tensors used in neighboring layers from among the plurality of layers are able to be shared;
allocate the data to the plurality of tensors by reducing and/or minimizing a region of the memory for allocating data corresponding to the plurality of tensors, based on the integrated execution order; and
train the neural network model according to the integrated execution order using the plurality of tensors and the data allocated to the plurality of tensors.

2. The apparatus as claimed in claim 1, wherein the first information is based on information regarding a type of step in which the plurality of tensors are used, from among the plurality of steps.

3. The apparatus as claimed in claim 1, wherein the type of step in which the plurality of tensors are used comprises types indicating each of the forward propagation step, the gradient calculation step, the derivative calculation step, a backpropagation step including the gradient calculation step and the derivative calculation step, a step including the forward propagation step and the backpropagation step, and an overall learning step of the neural network model.

4. The apparatus as claimed in claim 1, wherein the second information comprises first mode information indicating that tensors are in a pre-allocated state, second mode information indicating that a tensor needs to be newly created, third mode information indicating that data of a tensor is changed but the tensor is able to be shared with another tensor in a neighboring layer, fourth mode information indicating that data of a tensor is unchanged and the tensor is able to be shared with the another tensor, and fifth mode information indicating that a tensor is able to be shared with all tensors.

5. The apparatus as claimed in claim 4, wherein the at least one processor is individually and/or collectively configured to, based on an execution order of a step in which a first tensor from among the plurality of tensors is last used being equal to or faster than an execution order in which a second tensor of a layer adjacent to a layer of the first tensor is the first to first used, integrate at least a portion of the determined execution order so that the first tensor and the second tensor are shared.

6. The apparatus as claimed in claim 5, wherein the at least one processor is individually and/or collectively configured to, based on an execution order of a step in which a first tensor from among the plurality of tensors is last used being slower than an execution order of a step in which a second tensor of a layer adjacent to a layer of the first tensor is first used, if second information corresponding to the second tensor is the fourth mode information, integrate at least a portion of the determined execution order so that the first tensor and the second tensor are shared.

7. The apparatus as claimed in claim 1, wherein the at least one processor is individually and/or collectively configured to reduce and/or minimize a region of the memory by determining whether to further create a region of a memory for allocating data corresponding to the plurality of tensors or to overwrite a previously created region of memory, based on the integrated execution order.

8. A controlling method of an electronic apparatus, the method comprising:
dividing a learning step performed through a plurality of layers of a neural network model into a plurality of steps including a forward propagation step, a gradient calculation step, and a derivative calculation step, and determining an execution order of the plurality of steps;
obtaining first information regarding in which step of a plurality of steps according to the determined execution order a plurality of tensors used in the plurality of layers are to be used, based on the determined execution order;
integrating the determined execution order based on the first information and second information regarding whether tensors used in neighboring layers from among the plurality of layers are able to be shared;
allocating the data to the plurality of tensors by reducing and/or minimizing a region of the memory for allocating data corresponding to the plurality of tensors, based on the integrated execution order; and
training the neural network model according to the integrated execution order using the plurality of tensors and the data allocated to the plurality of tensors.

9. The method as claimed in claim 8, wherein the first information is determined based on information regarding a type of step in which the plurality of tensors are used, from among the plurality of steps.

10. The method as claimed in claim 8, wherein the type of step in which the plurality of tensors are used comprises types indicating each of the forward propagation step, the gradient calculation step, the derivative calculation step, a backpropagation step including the gradient calculation step and the derivative calculation step, a step including the forward propagation step and the backpropagation step, and an overall learning step of the neural network model.

11. The method as claimed in claim 8, wherein the second information comprises first mode information indicating that tensors are in a pre-allocated state, second mode information indicating that a tensor needs to be newly created, third mode information indicating that data of a tensor is changed but the tensor is able to be shared with another tensor in a neighboring layer, fourth mode information indicating that data of a tensor is unchanged and the tensor is able to be shared with the another tensor, and fifth mode information indicating that a tensor is able to be shared with all tensors.

12. The method as claimed in claim 11, wherein the integrating the determined execution order comprises, based on an execution order of a step in which a first tensor from among the plurality of tensors is last used being equal to or faster than an execution order in which a second tensor of a layer adjacent to a layer of the first tensor is first used, integrating at least a portion of the determined execution order so that the first tensor and the second tensor are shared.

13. The method as claimed in claim 12, wherein the integrating the determined execution order comprises, based on an execution order of a step in which a first tensor from among the plurality of tensors is last used being slower than an execution order of a step in which a second tensor of a layer adjacent to a layer of the first tensor is first used, if second information corresponding to the second tensor is the fourth mode information, integrating at least a portion of the determined execution order so that the first tensor and the second tensor are shared.

14. The method as claimed in claim 8, wherein the allocating the data to the plurality of tensors comprises reducing and/or minimizing a region of the memory by determining whether to further create a region of a memory for allocating data corresponding to the plurality of tensors or to overwrite a previously created region of memory, based on the integrated execution order.

15. A non-transitory computer readable recording medium including a program that executes a controlling method of an electronic apparatus, the controlling method of the electronic apparatus comprising:
dividing a learning step performed through a plurality of layers of the neural network model into a plurality of steps including a forward propagation step, a gradient calculation step, and a derivative calculation step, and determining an execution order of the plurality of steps;
obtaining first information regarding in which step of a plurality of steps according to the determined execution order a plurality of tensors used in the plurality of layers are used, based on the determined execution order;
integrating the determined execution order based on the first information and second information regarding whether tensors used in neighboring layers from among the plurality of layers are able to be shared;
allocating the data to the plurality of tensors by reducing and/or minimizing a region of the memory for allocating data corresponding to the plurality of tensors, based on the integrated execution order; and
training the neural network model according to the integrated execution order using the plurality of tensors and the data allocated to the plurality of tensors.
